(19) United States
(12) Patent Application Publication
(10) Pub. No.: US 2016/0056868 A1
(43) Pub. Date: Feb. 25, 2016

(54) BASE STATION AND COMMUNICATION CONTROL METHOD

(71) Applicant: KYOCERA CORPORATION, Kyoto (JP)

(72) Inventors: Hiroyuki ADACHI, Kawasaki-shi (JP); Kugo MORITA, Yokohama-shi (JP); Masato FUJISHIRO, Yokohama-shi (JP); Chiharu YAMAZAKI, Ota-ku (JP)

(73) Assignee: KYOCERA CORPORATION, Kyoto (JP)

(21) Appl. No.: 14/781,513

(22) PCT Filed: Apr. 3, 2014
(86) PCT No.: PCT/JP2014/059832

§ 371 Date: Sep. 30, 2015

(30) Foreign Application Priority Data
Apr. 5, 2013 (JP) 2013-079999

(51) Int. Cl. H04B 7/04; H04L 1/00

(52) U.S. Cl. CPC H04B 7/0421; H04B 7/0404; H04L 1/0003

(57) ABSTRACT

A base station according to a first aspect is configured to transmit a radio signal to a user terminal in an own cell by using a plurality of transmission antennas. The base station comprises: a controller configured to notify the user terminal of a multi-antenna transmission mode to be applied to a transmission of the radio signal; and a transmitter configured to transmit the radio signal by using the plurality of transmission antennas by the multi-antenna transmission mode notified to the user terminal. The controller reduces a number of transmission antennas to be used for the transmission of the radio signal so as to reduce power consumption of the base station. The controller maintains the multi-antenna transmission mode notified to the user terminal without changing the multi-antenna transmission mode, even when reducing the number of transmission antennas to be used for the transmission of the radio signal.

### TECHNICAL FIELD

The present invention relates to a base station and a communication control method used in a mobile communication system.

### BACKGROUND ART

In 3GPP (3rd Generation Partnership Project), which is a standardization project of a mobile communication system, the power-saving technology reducing power consumption of the base station is introduced (see, for example, Non Patent Literature 1). For example, at nighttime and the like with less communication traffic, the operation of a cell of the base station is stopped, whereby the power consumption of a base station can be reduced.

### CITATION LIST

### Non Patent Literature

Non Patent Literature 1: 3GPP technical specification “TS36.300 V11.4.0”, December 2012

### SUMMARY OF INVENTION

However, although it is possible to reduce the power consumption of the base station by the operation of the cell of the base station being stopped, there has been a problem that the communication with the user terminal becomes unavailable in the cell.

Thus, the present invention provides a base station and a communication control method capable of reducing power consumption, while reducing the impact on the communication with a user terminal.

A base station according to a first aspect is configured to transmit a radio signal to a user terminal in an own cell by using a plurality of transmission antennas. The base station comprises: a controller configured to notify the user terminal of a multi-antenna transmission mode to be applied to a transmission of the radio signal; and a transmitter configured to transmit the radio signal by using the plurality of transmission antennas by the multi-antenna transmission mode notified to the user terminal. The controller reduces a number of transmission antennas to be used for the transmission of the radio signal so as to reduce power consumption of the base station. The controller maintains the multi-antenna transmission mode notified to the user terminal without changing the multi-antenna transmission mode, even when reducing the number of transmission antennas to be used for the transmission of the radio signal.

A communication control method according to a second aspect is used in a base station configured to transmit a radio signal to a user terminal in an own cell by using a plurality of transmission antennas. The communication control method comprises the steps of: notifying the user terminal of a multi-antenna transmission mode to be applied to a transmission of the radio signal; transmitting the radio signal by using the plurality of transmission antennas by the multi-antenna transmission mode notified to the user terminal; reducing the number of transmission antennas to be used for the transmission of the radio signal so as to reduce power consumption of the base station; and maintaining the multi-antenna transmission mode notified to the user terminal without changing the multi-antenna transmission mode, even when reducing the number of transmission antennas to be used for the transmission of the radio signal.

### BRIEF DESCRIPTION OF DRAWINGS

FIG. 1 is a configuration diagram of an LTE system according to the first to fourth embodiments.

FIG. 2 is a block diagram of a UE according to the first to fourth embodiments.

FIG. 3 is a block diagram of an eNB according to the first to fourth embodiments.

FIG. 4 is a block diagram of a processor according to the first embodiment.

FIG. 5 is a protocol stack diagram of a radio interface in the LTE system.

FIG. 6 is a configuration diagram of a radio frame used in the LTE system.

FIG. 7 is a diagram for illustrating an operation summary according to the first embodiment.

FIG. 8 is a diagram for illustrating the operation of the eNB according to the first embodiment.

FIG. 9 is a diagram for illustrating the operation of the eNB according to the first embodiment.

FIG. 10 is a diagram for illustrating the operation of the eNB according to the first embodiment.

FIG. 11 is an operation flow diagram of an eNB according to a second embodiment.

FIG. 12 is an operation flow diagram of a UE according to a third embodiment.

FIG. 13 is a message configuration diagram according to a fourth embodiment.

FIG. 14 is a message configuration diagram according to the fourth embodiment.

FIG. 15 is a message configuration diagram according to the fourth embodiment.

FIG. 16 is a message configuration diagram according to the fourth embodiment.

FIG. 17 is a message configuration diagram according to the fourth embodiment.

### DESCRIPTION OF EMBODIMENTS

### Overview of Embodiments

A base station according to first to fourth embodiments is configured to transmit a radio signal to a user terminal in an own cell by using a plurality of transmission antennas. The base station comprises: a controller configured to notify the user terminal of a multi-antenna transmission mode to be applied to a transmission of the radio signal; and a transmitter configured to transmit the radio signal by using the plurality of transmission antennas by the multi-antenna transmission mode notified to the user terminal. The controller reduces a number of transmission antennas to be used for the transmission of the radio signal so as to reduce power consumption of the base station. The controller maintains the multi-antenna transmission mode notified to the user terminal without changing the multi-antenna transmission mode, even when reducing the number of transmission antennas to be used for the transmission of the radio signal.

In the first to fourth embodiments, the multi-antenna transmission mode is any one of: a transmission diversity; and a MIMO transmission based on a cell-specific reference signal. The controller maintains the multi-antenna transmission mode by generating a plurality of pieces of data corresponding to the plurality of transmission antennas to transmit only the data corresponding to a transmission antenna to be used for the transmission of the radio signal among the plurality of pieces of data, when reducing the number of transmission antennas to be used for the transmission of the radio signal.

In the first to fourth embodiments, the multi-antenna transmission mode is a MIMO transmission based on a demodulation reference signal. The controller maintains the multi-antenna transmission mode by generating only the data corresponding to a transmission antenna to be used for the transmission of the radio signal to transmit the generated data, when reducing the number of transmission antennas to be used for the transmission of the radio signal.

In the first to fourth embodiments, the controller changes the number of transmission antennas to be used for the transmission of the radio signal based on any one of: traffic conditions of the own cell; and a request from an adjacent base station.

In the second embodiment, the controller changes to a modulation and coding scheme having a lower data rate than a modulation and coding scheme applied to the transmission of the radio signal before reducing the number of transmission antennas, when reducing the number of transmission antennas to be used for the transmission of the radio signal.

In the second embodiment, the controller changes to a smaller amount of radio resource than a radio resource used for the transmission of the radio signal before reducing the number of transmission antennas, when reducing the number of transmission antennas to be used for the transmission of the radio signal.

In the second embodiment, when applying a first modulation and coding scheme corresponding to a first channel state information fed back from the user terminal to the transmission of the radio signal, and when reducing the number of transmission antennas to be used for the transmission of the radio signal, after reducing the number of transmission antennas, and until receiving a second channel state information fed back from the user terminal, the controller applies a second modulation and coding scheme having a lower data rate than the first modulation and coding scheme to the transmission of the radio signal.

In the third embodiment, the controller notifies the user terminal of antenna information on the number of transmission antennas, when reducing the number of transmission antennas to be used for the transmission of the radio signal. The antenna information is utilized for simplifying calculation of channel state information in the user terminal.

In the third embodiment, the controller notifies, to the user terminal configured to feed rank information not matching the number of transmission antennas back, the antenna information on the number of transmission antennas, when reducing the number of transmission antennas to be used for the transmission of the radio signal.

In the fourth embodiment, the controller notifies an adjacent base station of information on the number of transmission antennas to be used for the transmission of the radio signal.

In the fourth embodiment, the controller notifies request information on a change in the number of transmission antennas to be used for a transmission of a radio signal by an adjacent base station to the adjacent base station.

A communication control method according to first to fourth embodiments is used in a base station configured to transmit a radio signal to a user terminal in an own cell by using a plurality of transmission antennas. The communication control method comprises the steps of: notifying the user terminal of a multi-antenna transmission mode to be applied to a transmission of the radio signal; transmitting the radio signal by using the plurality of transmission antennas by the multi-antenna transmission mode notified to the user terminal; reducing the number of transmission antennas to be used for the transmission of the radio signal so as to reduce power consumption of the base station; and maintaining the multi-antenna transmission mode notified to the user terminal without changing the multi-antenna transmission mode, even when reducing the number of transmission antennas to be used for the transmission of the radio signal.

### First Embodiment

In the following, an embodiment when the present invention is applied to LTE (Long Term Evolution) standardized in 3GPP will be described with reference to the drawings.

(Configuration of LTE System)

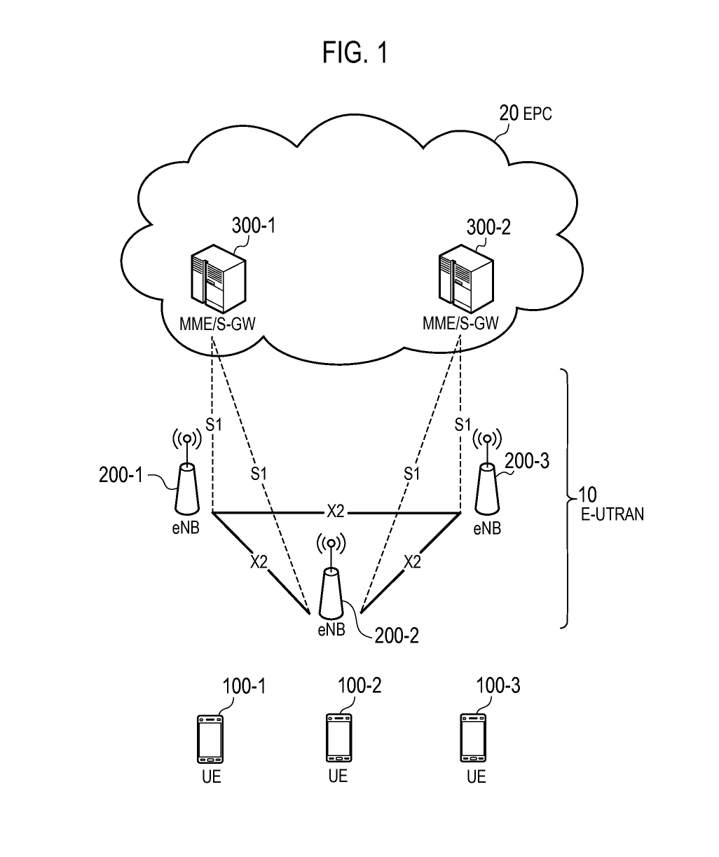

FIG. 1 is a configuration diagram of an LTE system according to the first embodiment. As shown in FIG. 1, the LTE system includes a plurality of UEs (User Equipment) 100, an E-UTRAN (Evolved-UMTS Terrestrial Radio Access Network) 10, and an EPC (Evolved Packet Core) 20. The E-UTRAN 10 corresponds to a radio access network, and the EPC 20 corresponds to a core network. The E-UTRAN 10 and the EPC 20 constitute a network of the LTE system.

The UE 100 is a mobile type communication device, and performs a radio communication with a cell of connection destination (serving cell). The UE 100 corresponds to a user terminal.

The E-UTRAN 10 includes a plurality of eNBs 200 (evolved Node-B). The eNB 200 corresponds to a base station. The eNB 200 manages one or more cells, and performs a radio communication with the UE 100 having established a connection with the own cell. It should be noted that in addition to being used as a term representing the minimum unit of a radio communication area, “cell” is also used as a term representing a function of performing radio communication with the UE 100.

The eNB 200 includes, for example, a radio resource management (RRM) function, a routing function of the user data, and a measurement control function for mobility control and scheduling.

The EPC 20 includes a plurality of MME (Mobility Management Entity)/S-GWs (Serving-Gateway) 300. The MME is a network node configured to perform various mobility controls and the like on the UE 100, and corresponds to a control station. The S-GW is a network node configured to perform transfer control of the user data, and corresponds to a switching center. The EPC 20 constituted by the MME/S-GWs 300 houses the eNBs 200.

The eNBs 200 are connected to each other through the X2 interface. In addition, the eNBs 200 are connected to the MME/S-GWs 300 through the S1 interface.

Next, the configuration of the UE 100 and the eNB 200 will be described.

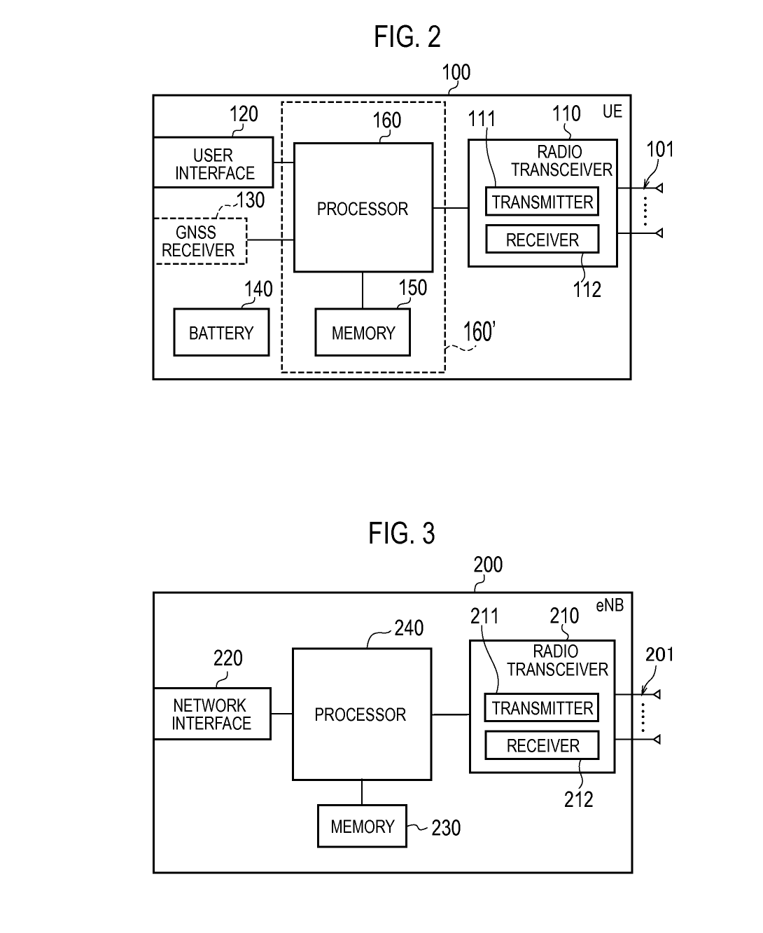

FIG. 2 is a block diagram of the UE 100. As shown in FIG. 2, the UE 100 includes a plurality of antennas 101, a radio transceiver 110, a user interface 120, a GNSS (Global Navigation Satellite System) receiver 130, a battery 140, a memory 150, and a processor 160. The memory 150 and the processor 160 constitute the controller. The UE 100 does not have to include the GNSS receiver 130. In addition, the memory 150 may be integrated with the processor 160, and this set (that is, chipset) may be referred to as a processor 160′.

The plurality of antennas 101 and the radio transceiver 110 are used for the transmission and reception of radio signals. The radio transceiver 110 includes a transmitter 111 configured to convert the baseband signal (transmission signal) output by the processor 160 into a radio signal to transmit from the plurality of antennas 101. In addition, the radio transceiver 110 includes a receiver 112 configured to convert the radio signal received by the plurality of antennas 101 into a baseband signal (received signal) to output to the processor 160.

The user interface 120 is an interface with a user who owns the UE 100, and includes, for example, a display, a microphone, a speaker, and various buttons. The user interface 120 receives operation from the user, and outputs signals indicating the contents of the operation to the processor 160. The GNSS receiver 130 receives the GNSS signal so as to obtain the positional information indicating the geographic location of the UE 100, to output the received signal to the processor 160. The battery 140 stores electric power to be supplied to each block of the UE 100.

The memory 150 stores the program executed by the processor 160, and the information used for the processing by the processor 160. The processor 160 includes a baseband processor configured to perform modulation, demodulation, coding, and decoding of a baseband signal, and a CPU (Central Processing Unit) configured to execute the program stored in the memory 150 to perform various kinds of processing. The processor 160 may further include a codec configured to perform encoding and decoding of audio and video signals. The processor 160 performs various kinds of processing and various communication protocols described below.

FIG. 3 is a block diagram of the eNB 200. As shown in FIG. 3, the eNB 200 includes a plurality of antennas 201, a radio transceiver 210, a network interface 220, a memory 230, and a processor 240. The memory 230 and the processor 240 constitute the controller.

The plurality of antennas 201 and the radio transceiver 210 are used for the transmission and reception of radio signals. The radio transceiver 210 includes a transmitter 211 configured to convert the baseband signal (transmission signal) output by the processor 240 into a radio signal to transmit from the plurality of antennas 201. In addition, the radio transceiver 210 includes a receiver 212 configured to convert the radio signal received by the plurality of antennas 201 into a baseband signal (received signal) to output to the processor 240.

The network interface 220 is connected to an adjacent eNB 200 through the X2 interface, and connected to a MME/S-GW 300 through the S1 interface. The network interface 220 is used for the communication performed on the X2 interface and the communication performed on the S1 interface.

The memory 230 stores the program executed by the processor 240, and the information used for the processing by the processor 240. The processor 240 includes a baseband processor configured to perform modulation, demodulation, coding, and decoding of a baseband signal, and a CPU configured to execute the program stored in the memory 230 to perform various kinds of processing. The processor 240 performs various kinds of processing and various communication protocols described below.

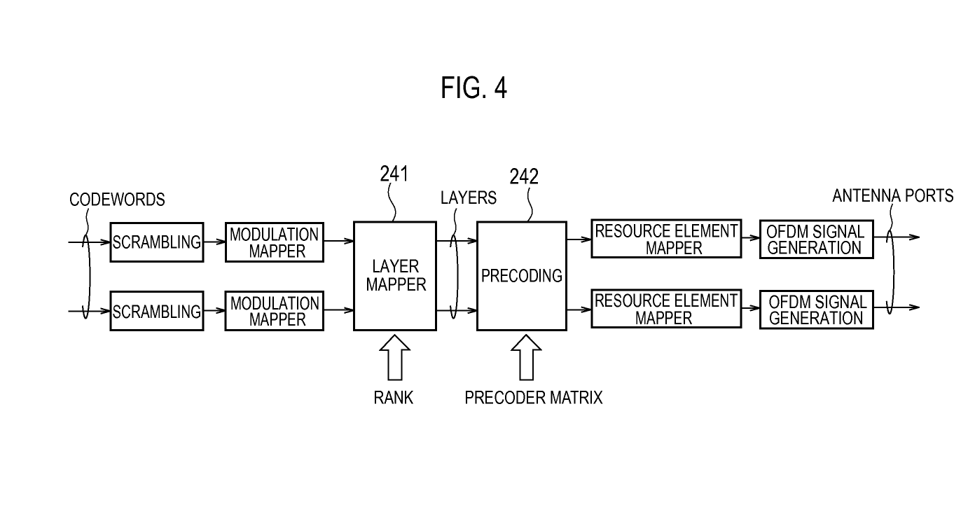

FIG. 4 is a block diagram of a processor 240 related to the downlink multi-antenna transmission. Although details of each block are described, for example, in 3GPP TS 36.211, the summary will be described here.

As shown in FIG. 4, after being scrambled and modulated into a modulation symbol, one or two codewords to be transmitted on the physical channel are mapped to a plurality of layers by the layer mapper 241. The codeword is a data unit of the error correction. The number of layers (rank) is determined based on the RI (Rank Indicator) to be fed back.

The precoding unit 242 precodes the modulation symbol of each layer by using a precoder. The precoder is determined based on the PMI (Precoding Matrix Indicator) to be fed back. The precoded modulation symbol is mapped to a resource element, and is converted into an OFDM signal in the time domain to be output to each antenna port.

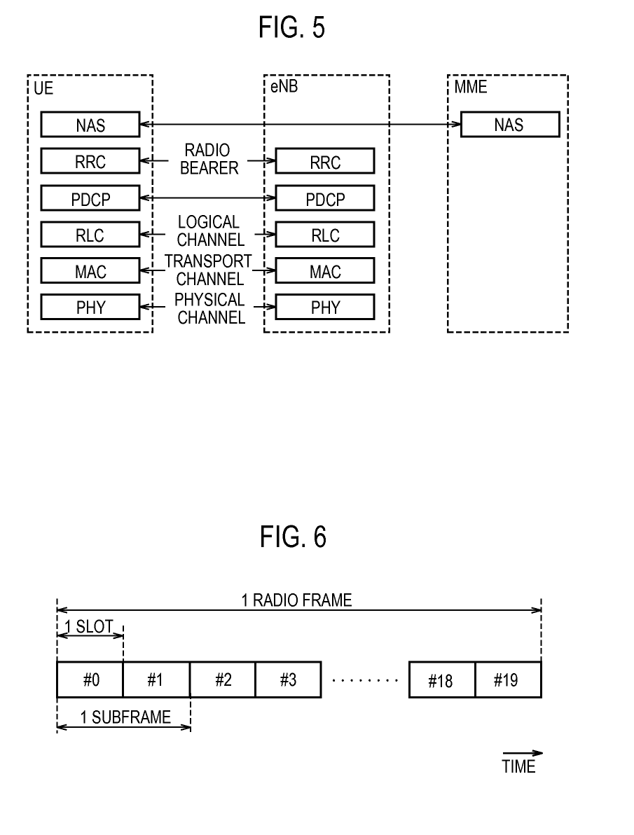

FIG. 5 is a protocol stack diagram of a radio interface in the LTE system. As shown in FIG. 5, the radio interface protocol is divided into the layers 1 to 3 of the OSI reference model, and the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The physical layer performs encoding and decoding, modulation and demodulation, antenna mapping and demapping, and resource mapping and demapping. Between the physical layers of the UE 100 and the eNB 200, data are transmitted through the physical channel.

The MAC layer performs the priority control of data, the retransmission processing by hybrid ARQ (HARQ), and the like. Between the MAC layers of the UE 100 and the eNB 200, data are transmitted through the transport channel. The MAC layer of the eNB 200 includes a scheduler determining the transport format of the uplink and downlink (transport block size, modulation and coding scheme (MCS)) and the allocation resource block.

The RLC layer transmits the data to the RLC layer on the receiving side by utilizing the functions of the MAC layer and the physical layer. Between the RLC layers of the UE 100 and the eNB 200, data are transmitted through the logical channel.

The PDCP layer performs the header compression and decompression, and the encryption and decryption.

The RRC layer is defined only in the control plane. Between the RRC layers of the UE 100 and the eNB 200, a control message for various settings (RRC message) is transmitted. The RRC layer controls the logical channel, the transport channel, and the physical channel depending on the establishment, the re-establishment, and the release of the radio bearer. If there is a RRC connection between the RRCs of the UE 100 and the eNB 200, the UE 100 is in the connected state (RRC connected state), otherwise the UE 100 is in the idle state (RRC idle state).

The NAS (Non-Access Stratum) layer positioned in an upper level of the RRC layer performs the session management, the mobility management, and the like.

FIG. 6 is a configuration diagram of a radio frame used in the LTE system. In the LTE system, OFDMA (Orthogonal Frequency Division Multiplexing Access) is applied to the downlink, and SC-FDMA (Single Carrier Frequency Division Multiple Access) is applied to the uplink.

As shown in FIG. 6, the radio frame includes 10 subframes lined up in the time direction, and each subframe includes 2 slots lined up in the time direction. The length of each subframe is 1 ms, and the length of each slot is 0.5 ms. Each subframe includes a plurality of resource blocks (RB) in the frequency direction and a plurality of symbols in the time direction. The resource block includes a plurality of subcarriers in the frequency direction. Among the radio resources allocated to the UE 100, the frequency resource can be specified by the resource block, and the time resource can be specified by the subframe (or slot).

In the downlink, the period of the first several symbols of each subframe is a control area used as a physical downlink control channel (PDCCH) mainly for transmitting a control signal. In addition, the remaining period of each subframe is an area usable as a physical downlink shared channel (PDSCH) mainly for transmitting user data.

The PDCCH carries a control signal. The control signal includes, for example, uplink SI (Scheduling Information), downlink SI, and the TPC bit. The uplink SI is the information indicating the allocation of the uplink radio resource, and the downlink SI is the information indicating the allocation of the downlink radio resource. The TPC bit is the information instructing the increase or decrease of the transmission power of the uplink. These pieces of information are referred to as downlink control information (DCI).

The PDSCH carries a control signal and/or user data. For example, the data area of the downlink may be allocated only to the user data, and may be allocated so that the user data and the control signal are multiplexed.

In the uplink, both ends in the frequency direction in each subframe are the control areas used as a physical uplink control channel (PUCCH) mainly for transmitting a control signal. In addition, the central portion in the frequency direction in each subframe is an area usable as a physical uplink shared channel (PUSCH) mainly for transmitting user data.

The PUCCH carries a control signal. The control signal is, for example, CQI (Channel Quality Indicator), PMI (Precoding Matrix Indicator), RI (Rank Indicator), SR (Scheduling Request), ACK/NACK, and the like. The CQI is the information indicating the channel quality of the downlink, and is used for the determination and the like of the recommended modulation scheme and coding rate to be used for the downlink transmission. The PMI is the information indicating the precoder matrix desirable to be used for the transmission of the downlink. The RI is the information indicating the number of layers (the number of streams) usable for the transmission of the downlink. The SR is the information requesting the allocation of the uplink radio resource (resource block). The ACK/NACK is the information indicating whether the decoding of the signal transmitted via the physical channel of the downlink (for example, PDSCH) is successful. It should be noted that the CQI, the PMI, and the RI are referred to as the channel state information (CSI).

The PUSCH carries a control signal and/or user data. For example, the data area of the uplink may be allocated only to the user data, and may be allocated so that the user data and the control signal are multiplexed.

(Operation According To First Embodiment)

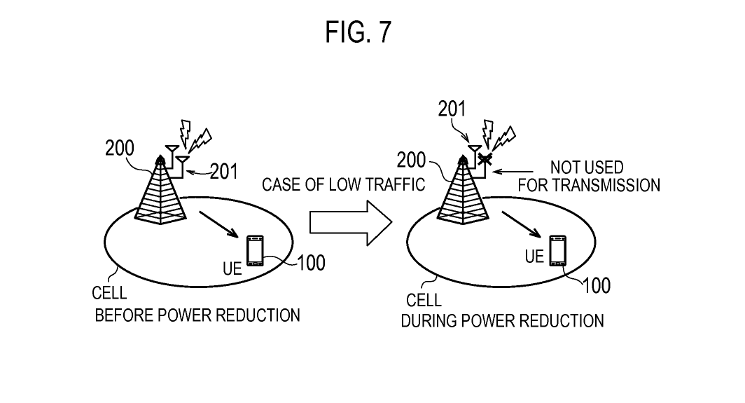

FIG. 7 is a diagram for illustrating an operation summary according to the first embodiment. As shown in FIG. 7, the UE 100 in the connection state is located in the cell of the eNB 200. The eNB 200 transmits radio signals to the UE 100 by using a plurality of antennas (a plurality of transmission antennas) 201.

In the first embodiment, the processor 240 of the eNB 200 changes the number of antennas to be used for transmitting radio signals (hereinafter referred to as “the number of active antennas”) based on the traffic conditions of the cell of the eNB 200. The traffic conditions means the number of connected UEs, transmission and reception data amount, radio resource usage rate, or the like in a cell. The processor 240 transmits radio signals from the transmitter 211 by using all of the antennas 201 when being in a high-traffic state. In contrast, the processor 240 transmits radio signals from the transmitter 211 by using only part of the antennas 201 when being in a low-traffic state. The number of active antennas is reduced, whereby the transmission power of the transmitter 211 (in particular, power amplifier) and the like can be reduced.

Alternatively, the processor 240 of the eNB 200 may change the number of active antennas based on the request information received by the network interface 220 from the adjacent eNB 200. Details of such request information will be described in the fourth embodiment.

The eNB 200 supports the multi-antenna transmission. The multi-antenna transmission mode includes the transmission diversity (SFBC, SFBC/FSTD), the MIMO transmission based on the cell-specific reference signal (CRS), the MIMO transmission based on the demodulation reference signal (DMRS), and the like.

The eNB 200 notifies the UE 100 of the multi-antenna transmission mode to be applied to the transmission of radio signals by the RRC message, for example, when starting communication with the UE 100. In addition, the eNB 200 transmits the number of antennas (transmission antennas) 201 to the UE 100 by the broadcast information or the RRC message.

Then, the eNB 200 transmits radio signals by using a plurality of antennas 201 by the multi-antenna transmission mode notified to the UE 100. The eNB 200 maintains the multi-antenna transmission mode notified to the UE 100 without changing the multi-antenna transmission mode even when reducing the number of active antennas.

When the eNB 200 changes the multi-antenna transmission mode notified to the UE 100 by reducing the number of active antennas, the UE 100 is disabled from communicating in the period until the change is applied. In the first embodiment, the multi-antenna transmission mode notified to the UE 100 is maintained without changing the multi-antenna transmission mode, and therefore the continuity of the communication is maintained.

When the multi-antenna transmission mode notified to the UE 100 is the MIMO transmission based on the transmission diversity or the CRS, the processor 240 of the eNB 200 maintains the multi-antenna transmission mode by the following control. Specifically, the processor 240 generates a plurality of pieces of data corresponding to the plurality of antennas 201 when reducing the number of active antennas. Then, the processor 240 causes the transmitter 211 to transmit only the data corresponding to the antennas 201 to be used for the transmission of radio signals among the plurality of pieces of generated data.

In addition, when the multi-antenna transmission mode notified to the UE 100 is the MIMO transmission based on the DMRS, the processor 240 of the eNB 200 maintains the multi-antenna transmission mode by the following control. Specifically, the processor 240 the processor 240 generates only the data corresponding to the antennas to be used for the transmission of radio signals when reducing the number of active antennas. Then, the processor 240 causes the transmitter 211 to transmit the generated data.

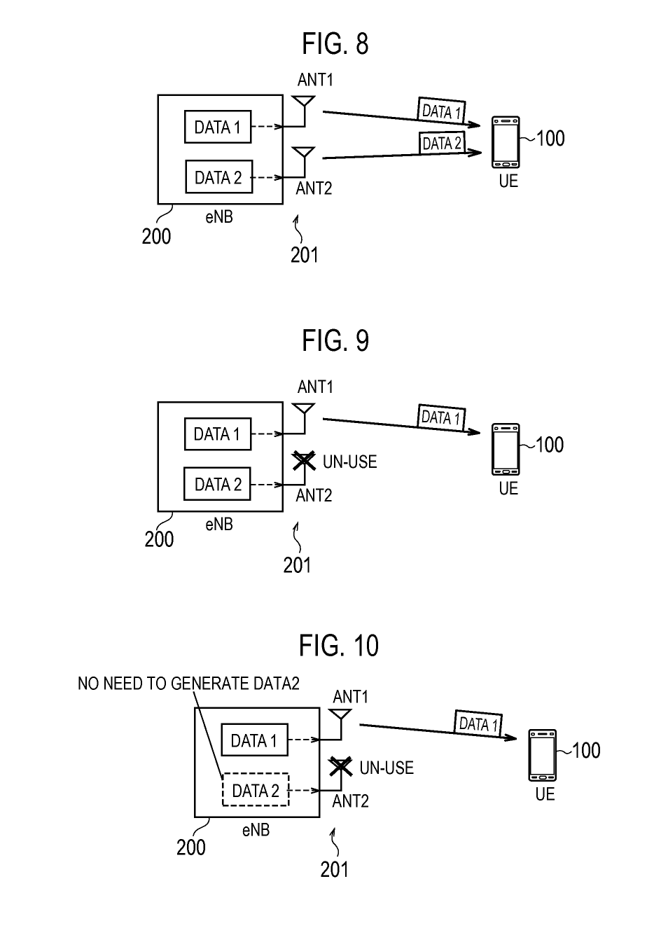

FIGS. 8 to 10 are diagrams for illustrating the operation of the eNB 200 according to the first embodiment.

As shown in FIG. 8, by using two antennas (Ant1, Ant2), the eNB 200 transmits data (Data1, Data2) from the respective antennas to the UE 100. For example, in the case of MIMO transmission, and when the number of transmission layers (rank) is two, the eNB 200 generates two pieces of data (Data1, Data2) and transmits the generated two pieces of data (Data1, Data2) by mapping the two layers of data (two series of data) to the two antennas (Ant1, Ant2) based on the precoder.

As shown in FIG. 9, when the multi-antenna transmission mode notified to the UE 100 is the transmission diversity or the MIMO transmission based on the CRS, it is assumed that the antennas to be used is reduced to only Ant1. When the transmission diversity is used, the same data is transmitted from each antenna (Ant1, Ant2), and therefore there is no particular problem even when the antennas to be used are reduced to only Ant1. On the other hand, when the MIMO transmission is used, the eNB 200 changes the number of transmission layers (rank) from two to one. Then, one layer of data (a series of data) are mapped to two antennas (Ant1, Ant2) based on the precoder, whereby two pieces of data (Data1, Data2) are generated, and only one piece of data of them (Data1) is transmitted. When the number of transmission antennas is the number of transmission layers or more, the UE 100 can decode the original data sequence. In addition, the UE 100 recognizes that the number of transmission layers (rank) is lowered while the number of antennas to be used is unchanged.

As shown in FIG. 10, when the multi-antenna transmission mode notified to the UE 100 is the MIMO transmission based on the DMRS, it is assumed that the antennas to be used are reduced to only Ant1. In the MIMO transmission based on the DMRS, the eNB 200 can specify the antenna port (antenna number) of the DMRS to be used for decoding by the UE 100. Therefore, the eNB 200 designates the UE 100 to use the DMRS of the Ant1 for decoding. Then, the eNB 200 transmits only one piece of data (Data1) from the Ant1. The UE 100 recognizes that the number of transmission layers (rank) is lowered while the number of antennas to be used is unchanged.

Thus, according to the first embodiment, even when the number of active antennas is changed, the UE 100 can perform the communication without changing the multi-antenna transmission mode while recognizing that the number of antennas of the eNB 200 is the same as before, and the continuity of the communication is maintained.

### Second Embodiment

The second embodiment will be described mainly by showing different points from the first embodiment.

In the first embodiment described above, the number of active antennas is reduced, whereby the reception power at the UE 100 is reduced as compared with before the number of active antennas is reduced. Thus, in the second embodiment, the communication quality is maintained by any one of the following first to third methods, depending on the reduction in the number of active antennas.

As a first method, when reducing the number of active antennas, the eNB 200 changes to the MCS having a lower data rate than the modulation and coding scheme (MCS) applied to the transmission of radio signals to the UE 100 before the number of antennas is reduced. The MCS having a lower data rate has a higher error tolerance, and therefore the communication quality can be maintained even when the reception power in the UE 100 is reduced.

As a second method, when reducing the number of active antennas, the eNB 200 changes to the smaller amount of radio resource than the radio resource used for the transmission of radio signals to the UE 100 before the number of antennas is reduced. Specifically, by reducing the number of allocated resource blocks, the eNB 200 can increase the power density per resource block (or subcarrier), reduce the decrease of the reception power at the UE 100, and maintain the communication quality.

As a third method, when reducing the number of active antennas, the eNB 200 changes to the larger amount of radio resource than the radio resource used for the transmission of radio signals to the UE 100 before the number of antennas is reduced, and causes the data to have redundancy (for example, the repetition is performed). Thereby, when there is a margin for the radio resource, the communication quality can be maintained.

As a fourth method, when applying the first MCS corresponding to the first channel state information (such as CQI) fed back from the UE 100 to the transmission of radio signals, and when reducing the number of active antennas, the eNB 200 applies the second MCS having a lower data rate than the first MCS to the transmission of radio signals, after reducing the number of active antennas until receiving the second channel state information to be fed back from the UE 100. As a result, the degradation of communication quality due to the reduction in the number of active antennas can be guessed, and more appropriate MCS can be used, and therefore the degradation of communication quality due to the increase in transmission error can be reduced.

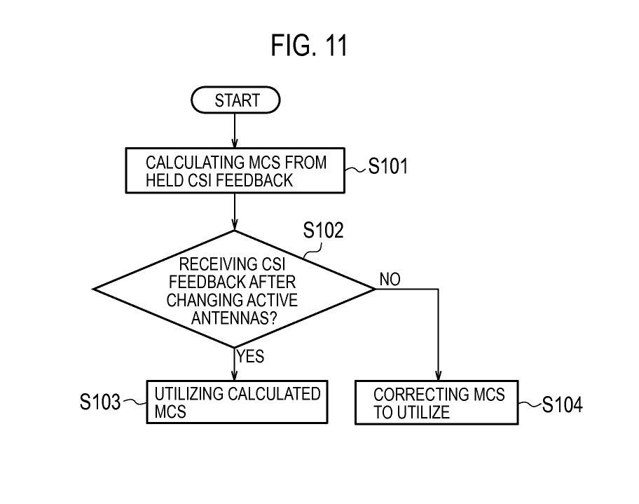

FIG. 11 is a flow diagram of the fourth method. As shown in FIG. 11, the eNB 200 holds the channel state information (such as CQI) fed back from the UE 100 (step S101). If receiving the channel state information newly fed back from the UE 100 after reducing the number of active antennas (YES in step S102), the eNB 200 utilizes the MCS calculated from the newly fed back channel state information (step S103). In contrast, if not receiving the channel state information newly fed back from the UE 100 after reducing the number of active antennas (NO in step S102), the eNB 200 corrects the MCS to a MCS lower than the MCS calculated from the held channel state information to utilize (step S104).

### Third Embodiment

The third embodiment will be described mainly by showing different points from the first and second embodiments.

In the first embodiment described above, even when the eNB 200 reduces the number of active antennas, the UE 100 does not recognize the reduction in the number of active antennas. Therefore, the UE 100 calculates the channel state information for the number of antennas greater than the actual number of active antennas, and therefore there is room for reducing the processing load on the UE 100.

Thus, in the third embodiment, when reducing the number of active antennas, the eNB 200 notifies the UE 100 of the antenna information on the number of active antennas by the RRC message. The antenna information is utilized for simplifying the calculation of the channel state information in the UE 100. It should be noted that the antenna information is not limited to the number of active antennas of the eNB 200, and may be the upper limit number of layers of the downlink (upper limit rank). In addition, the antenna information may be notified by the broadcast (such as SIB), and may be notified by the unicast (such as RRC message or DCI).

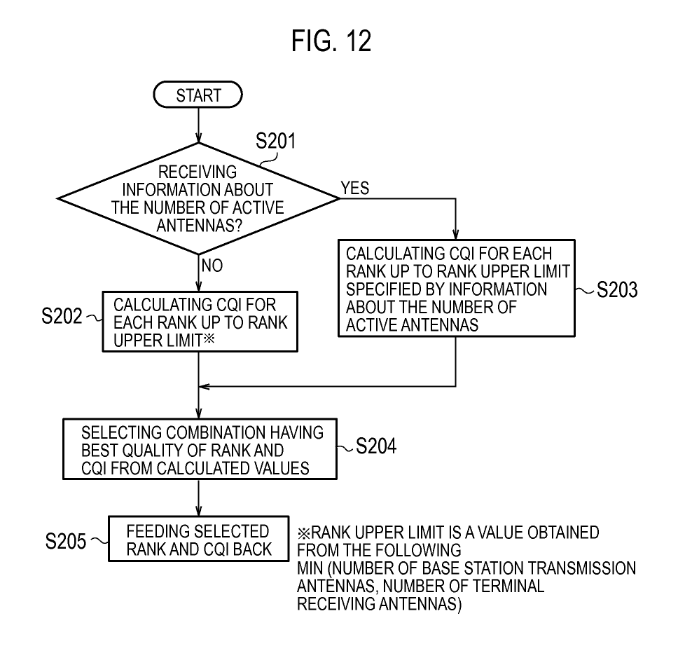

FIG. 12 is an operation flow diagram of the UE 100 according to the third embodiment. Here, the calculation of the CQI being one of the channel state information will be described as an example.

As shown in FIG. 12, if not receiving the antenna information (information on the number of active antennas) from the eNB 200 (NO in step S201), the UE 100 calculates the CQI for the number of all the transmission layers (rank) (step S202). On the other hand, if receiving the antenna information (information on the number of active antennas) from the eNB 200 (YES in step S201), the UE 100 calculates the CQI only for the number of transmission layers (rank) corresponding to the antenna information (step S203). Then, the UE 100 selects the combination having best quality of the number of transmission layers (rank) and the CQI among the combinations of the calculated number of transmission layers (rank) and CQI (step S204), and feeds the selected combination back (step S205).

If the method of the third embodiment is set individually to all the UEs 100 to be the target, the amount of the communication increases. Therefore, in this modification, when reducing the number of active antennas, the eNB 200 notifies the antenna information on the number of active antennas to the UE 100 that feeds the rank information (RI) not matching the number of active antennas back. Thereby, the terminals to be applied to can be selected by being limited to the UE 100 that feeds the wrong rank information (RI) back (for example, the UE 100 that feeds rank 2 back to the eNB 200 having the number of active antennas being one).

In addition, the UE 100 may notify the eNB 200 of the information on whether the processing is simplified (ACK/Nack) so that the eNB 200 can grasp whether the antenna information on the number of active antennas is applied to the UE 100. For example, when increasing the number of active antennas, the eNB 200 may retransmit the antenna information until the ACK can be received.

### Fourth Embodiment

The fourth embodiment will be described mainly by showing different points from the first to third embodiments.

In the power-saving state where the number of active antennas is reduced, the transmission capacity of the eNB 200 is not fully operated, and therefore it is necessary to increase the number of active antennas in response to a change in traffic conditions and to return the transmission capacity to the original. In this case, the eNB 200 is desirable to have a mechanism for performing the notification of the change in the number of active antennas of its own and the change request of the number of active antennas of the adjacent eNB 200 so as to correspond also to the change in the communication environment of the adjacent eNB 200.

Thus, in the fourth embodiment, the eNB 200 notifies the adjacent eNB 200 of the information on the number of active antennas. In addition, the eNB 200 notifies the adjacent eNB 200 of the request information on the change in the number of active antennas in the adjacent eNB 200.

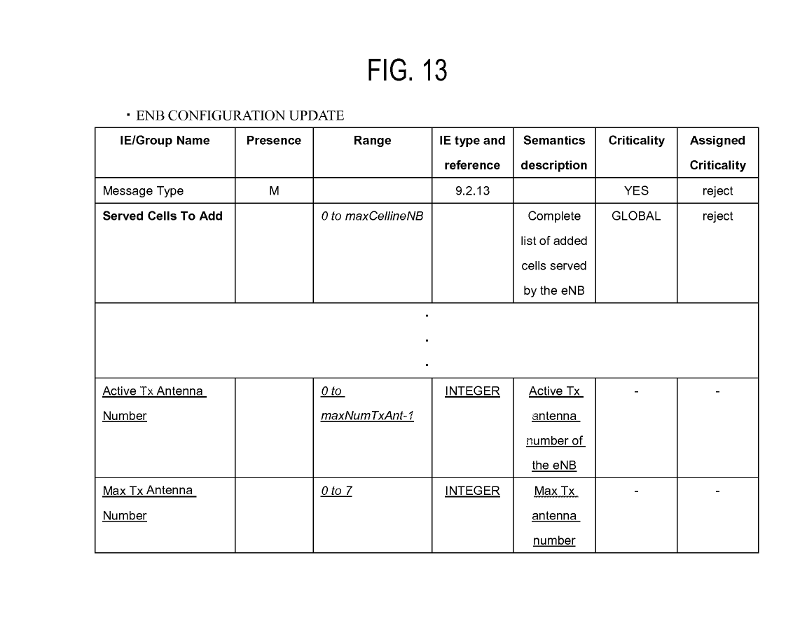

FIG. 13 is a diagram illustrating a message configuration example when the ENB CONFIGURATION UPDATE message being a kind of X2 message includes the information on the number of active antennas. In the example of FIG. 13, the ENB CONFIGURATION UPDATE message includes the number of active antennas (Active Tx Antenna Number) and the maximum number of antennas (Max Tx Antenna Number).

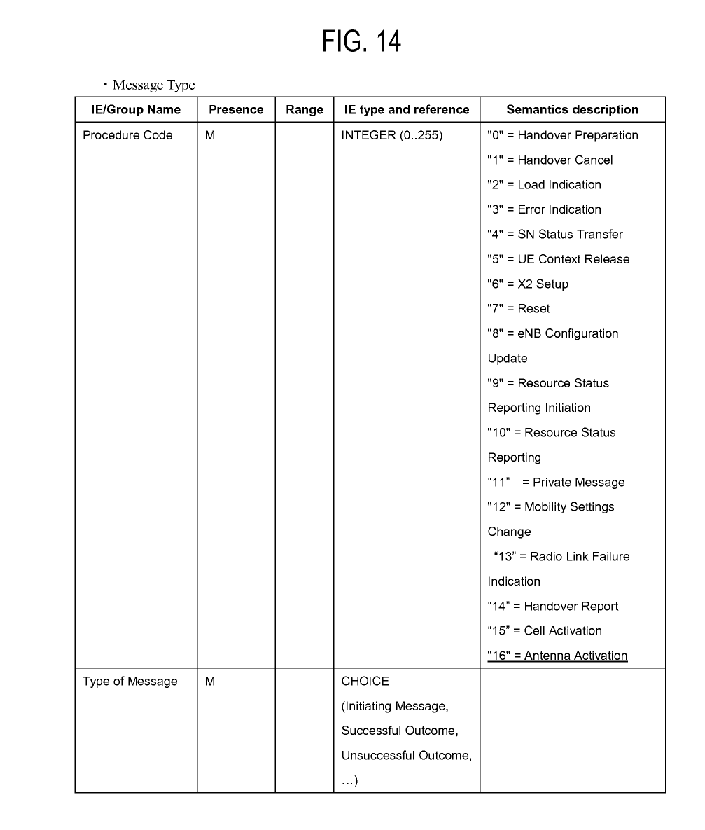

FIG. 14 is a diagram illustrating a configuration example of the message type of the ENB CONFIGURATION UPDATE message (Message Type). As shown in FIG. 14, the Antenna Activation indicating that the number of antennas is returned to the original is added as a new message type of the ENB CONFIGURATION UPDATE message.

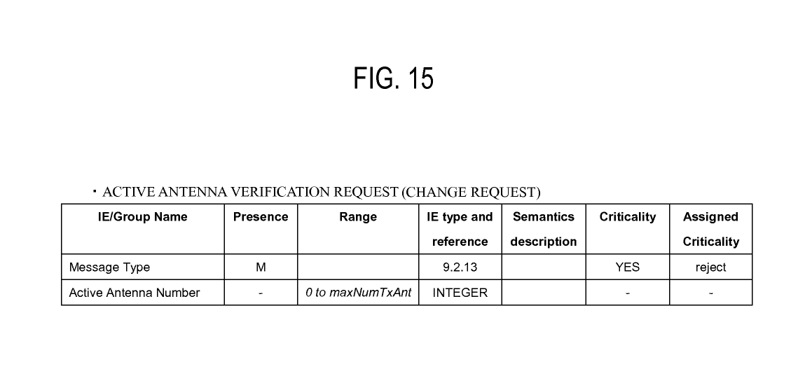

FIG. 15 is a diagram illustrating a configuration example of a new message (ACTIVE ANTENNA VERIFICATION REQUEST) requesting a change in the number of active antennas to the adjacent eNB 200. As shown in FIG. 15, the information indicating the number of active antennas to be requested (Active Antenna Number) is included.

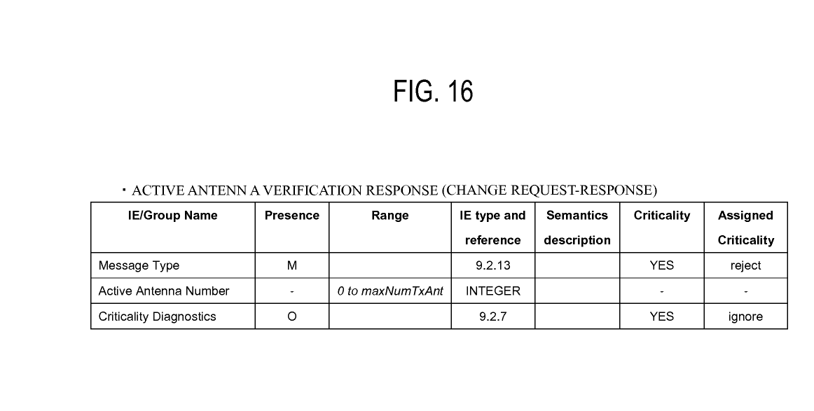

FIG. 16 is a diagram illustrating a configuration example of a response message (ACTIVE ANTENNA VERIFICATION RESPONSE) to the change request of the number of active antennas from the adjacent eNB 200. As shown in FIG. 16, the information indicating the number of active antennas after the change (Active Antenna Number) is included.

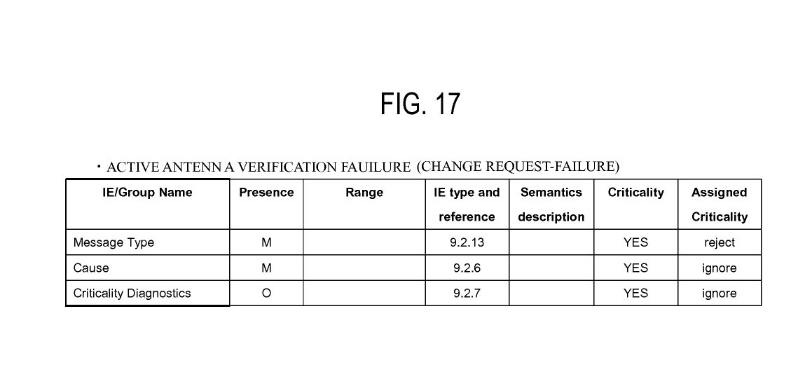

FIG. 17 is a diagram illustrating a configuration example of a failure message (ACTIVE ANTENNA VERIFICATION FAUILURE) to the change request of the number of active antennas from the adjacent eNB 200. As shown in FIG. 17, the information indicating the cause of the failure (Cause) is included.

### Other Embodiments

Although the eNB 200 changes the number of active antennas based on its own traffic conditions in the above-described embodiments, the eNB 200 may change the number of active antennas based on the request signal (message) from the adjacent eNB 200.

In addition, each of the embodiments described above is not limited to the case of being implemented separately and independently, and can be implemented in combination with one another.

In addition, although the case of applying the present invention to the LTE system is mainly described in each embodiment described above, the present invention is not limited to the LTE system and may be applied to systems other than the LTE system.

The entire contents of Japanese Patent Application No. 2013-079999 (filed on Apr. 5, 2013) are incorporated herein by reference.

### INDUSTRIAL APPLICABILITY

The present invention is useful in the mobile communication field.

1. A base station configured to transmit a radio signal to a user terminal in an own cell, the base station comprising:
a controller configured to notify the user terminal of a multi-antenna transmission mode to be applied to a transmission of the radio signal; and
a transmitter configured to transmit the radio signal by using a plurality of transmission antennas by the multi-antenna transmission mode to the user,
wherein the controller reduces a number of transmission antennas to be used for the transmission of the radio signal after notifying the user terminal of the multi-antenna transmission mode, and
the controller maintains the multi-antenna transmission mode, even when reducing the number of transmission antennas to be used for the transmission of the radio signal.

2. The base station according to claim 1,
wherein the multi-antenna transmission mode is any one of: a transmission diversity; and a MIMO transmission based on a cell-specific reference signal, and
the controller maintains the multi-antenna transmission mode by generating a plurality of pieces of data corresponding to the plurality of transmission antennas to transmit only the data corresponding to a transmission antenna to be used for the transmission of the radio signal among the plurality of pieces of data, when reducing the number of transmission antennas to be used for the transmission of the radio signal.

3. The base station according to claim 1,
wherein the multi-antenna transmission mode is a MIMO transmission based on a demodulation reference signal, and
the controller maintains the multi-antenna transmission mode by generating only the data corresponding to a transmission antenna to be used for the transmission of the radio signal to transmit the generated data, when reducing the number of transmission antennas to be used for the transmission of the radio signal.

4. The base station according to claim 1, wherein the controller changes the number of transmission antennas to be used for the transmission of the radio signal based on any one of: traffic conditions of the own cell; and a request from an adjacent base station.

5. The base station according to claim 1, wherein the controller changes to a modulation and coding scheme having a lower data rate than a modulation and coding scheme applied to the transmission of the radio signal before reducing the number of transmission antennas, when reducing the number of transmission antennas to be used for the transmission of the radio signal.

6. The base station according to claim 1, wherein the controller changes to a smaller amount of radio resource than a radio resource used for the transmission of the radio signal before reducing the number of transmission antennas, when reducing the number of transmission antennas to be used for the transmission of the radio signal.

7. The base station according to claim 1, wherein when applying a first modulation and coding scheme corresponding to a first channel state information fed back from the user terminal to the transmission of the radio signal, and when reducing the number of transmission antennas to be used for the transmission of the radio signal, after reducing the number of transmission antennas, and until receiving a second channel state information fed back from the user terminal, the controller applies a second modulation and coding scheme having a lower data rate than the first modulation and coding scheme to the transmission of the radio signal.

8. The base station according to claim 1,
wherein the controller notifies the user terminal of antenna information on the number of transmission antennas, when reducing the number of transmission antennas to be used for the transmission of the radio signal, and
the antenna information is utilized for simplifying calculation of channel state information in the user terminal.

9. The base station according to claim 8, wherein the controller notifies, to the user terminal configured to feed rank information not matching the number of transmission antennas back, the antenna information on the number of transmission antennas, when reducing the number of transmission antennas to be used for the transmission of the radio signal.

10. The base station according to claim 1, wherein the controller notifies an adjacent base station of information on the number of transmission antennas to be used for the transmission of the radio signal.

11. The base station according to claim 1, wherein the controller notifies request information on a change in the number of transmission antennas to be used for a transmission of a radio signal by an adjacent base station to the adjacent base station.

12. A communication control method used in a base station configured to transmit a radio signal to a user terminal in an own cell, the communication control method comprising the steps of:
notifying the user terminal of a multi-antenna transmission mode to be applied to a transmission of the radio signal;
reducing a number of transmission antennas to be used for the transmission of the radio signal
maintaining the multi-antenna transmission mode, even when reducing the number of transmission antennas to be used for the transmission of the radio signal; and
transmitting the radio signal by the multi-antenna transmission mode.

13. A processor for controlling a base station configured to transmit a radio signal to a user terminal in an own cell, the processor comprising the steps of:
notifying the user terminal of a multi-antenna transmission mode to be applied to a transmission of the radio signal;
reducing the number of transmission antennas to be used for the transmission of the radio signal;
maintaining the multi-antenna transmission mode, even when reducing the number of transmission antennas to be used for the transmission of the radio signal; and
transmitting the radio signal by the multi-antenna transmission mode.
